(19) United States
(12) Patent Application Publication
(10) Pub. No.: US 2002/0174170 A1
(43) Pub. Date: Nov. 21, 2002

(54) Method and system for distributing messages to agents

(76) Inventors: Serge Ioffe, South San Francisco, CA (US); Lev Shur, Walnut Creek, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/943,903

(22) Filed: Aug. 30, 2001

Related U.S. Application Data
(60) Provisional application No. 60/292,835, filed on May 21, 2001.

(51) Int. Cl. G06F 15/16

(52) U.S. Cl. 709/201; 709/206

(57) ABSTRACT

A method and system for subdividing sections of a message requesting action and routing the sections of the message to the appropriate agent is disclosed. In an alternative embodiment, the subsets of the message are reviewed again to determine if a subsequent response is needed, and sent to an agent to provide the subsequent response. The message, in an alternative embodiment, is analyzed to determine if subsets of the message have been responded to by agents, and if not responded to, are sent again to agents to provide a response.

The present application claims priority to the provisional filed application entitled Multimedia Message-Initiated Action Prompt, filed on May 21, 2001, U.S. Ser. No. 60/292,835, which is also incorporated herein by reference.

### FIELD OF THE INVENTION

The present invention relates to the field of data communications.

### BACKGROUND OF THE INVENTION

In today's service businesses, customers often communicate through a variety of media. The media may include an email, phone call, fax, scanned copy of a letter, voice mail, or other form of communication. The customer communications have to be sorted when coming into the customer service center of a business, analyzed and then distributed to various customer service representatives for response.

Many such systems are well known to those skilled in the art. Such systems may include those disclosed in Galdes, U.S. Pat. No. 6,177,932, entitled Method and Apparatus for Network Based Customer Service, and Miloslavsky, U.S. Pat. No. 5,765,033, entitled System for Routing Emails. A system that allows for routed customer communications may extract information from an email and then match the extracted information with a skill set of a particular agent. The full email is then sent on to the appropriate agent for a response. This system allows emails to be routed to the correct customer service representative without wasting time reading through unnecessary material.

FIG. 1 shows the architecture of a system illustrative of the Prior Art. An incoming message 100, such as an email, phone call, etc., is received into a storage device 101, such as a computer, a server, etc. The message is put through analyzing logic (e.g., software or circuitry) 102, where the analysis is based on a host of parameters, such as addressee, sender, the content, or a variety of other analysis criteria. The message 100 is passed through optional intermediate queues 103a-n to customer service representatives (CSRs) 110, 11a-n or 112.

A queue 103a may then direct an instance 100a of a message 100 that has been analyzed to a single CSR station 110. A queue 103b may instead be addressed to a cluster of customer service representatives 111a-n, and the first available customer service representative receives the message. In other cases, an instance 100n of a message may be sent to a robotic customer service representative 112 that may return an automatic response to the customer. The automatic response may be a first response or a final response to the instance 100n of a message. The robotic CSR 112 may be a server.

However, a problem involved in using systems such as the one described above is that customers often combine a variety of issues into a single message when communicating with a business. The customers may have several action requests that need several CSRs to handle each specific request. Simple, rule-based routing is therefore not sufficient to address all the various issues or requests raised in the message. The customer service representative to whom the initial message is routed then has to determine which other representatives should be contacted to respond to other issues in the message and manually route the message to these additional CSRs. The rerouting procedure results in an inefficient use of time and an overlap or a gap in attention to the problems involved in the message.

What is needed then is a method and system that allow a message requesting action to be routed to selected agents based on message subsets rather than the full message.

### SUMMARY OF THE INVENTION

In one embodiment, a method and system for subdividing sections of a message requesting action and routing the sections to a selected agent based on the section content is disclosed. In an alternative embodiment, the message is reviewed to determine whether responses have been given to the subsets of the message, and if no response has been given, the subsets are sent again to an agent. In one embodiment, the message is analyzed to determine whether a subsequent response is needed as a follow-up to the initial response by the agent.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is an illustration of the system architecture of the Prior Art in which the system is employed to distribute messages to specific agents.

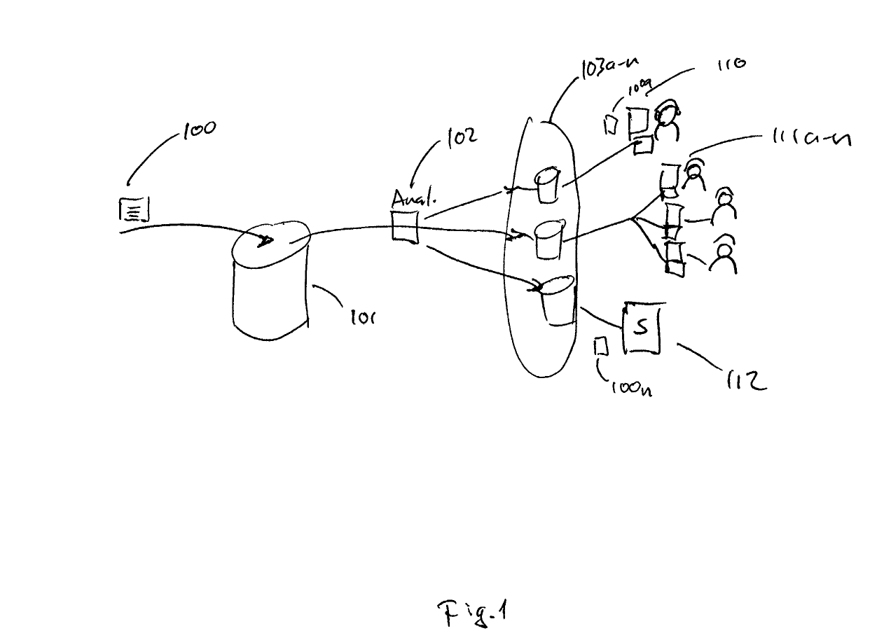

FIG. 2 is an illustration of the architecture of a system employed to subdivide portions of a message to be sent to a selected agent, according to one embodiment.

FIG. 3 is a flow diagram describing a process for the message distribution, according to one embodiment.

### DETAILED DESCRIPTION

In the following description, various aspects of the present invention will be described. However, it will be apparent to those skilled in the art that the present invention may be practiced with only some or all aspects of the present invention. For purposes of explanation, specific configurations are set forth in order to provide a thorough understanding of the present invention. However, it will also be apparent to one skilled in the art that the present invention may be practiced without the specific details. In other instances, well-known features are omitted or simplified in order not to obscure the present invention.

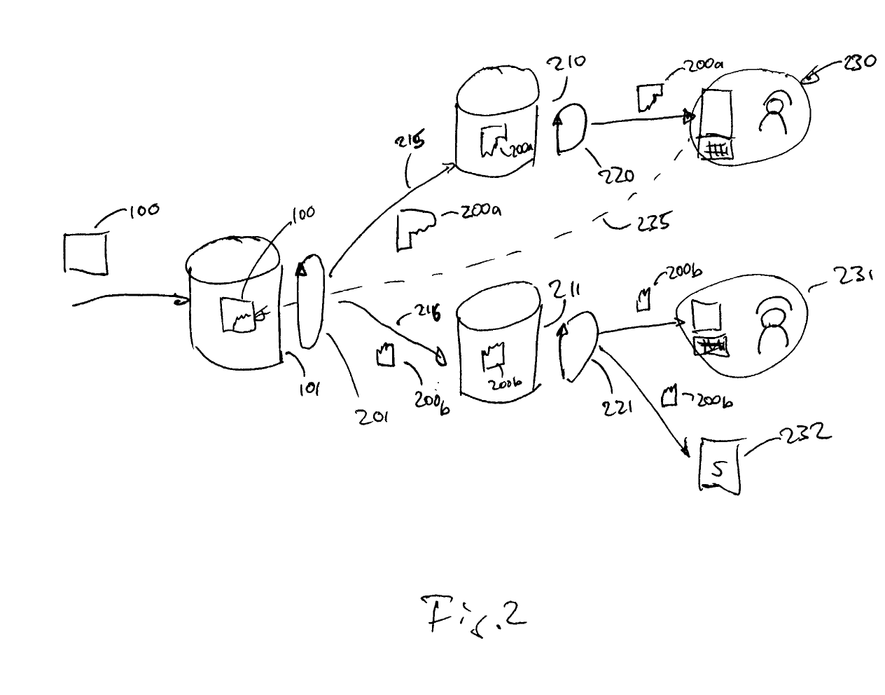

Referring now to FIG. 2, architecture of a system in which a message is subdivided then routed to selected agents is shown, according to one embodiment. A message 100 is received into a storage device 101. In alternative embodiments, the message 100 could be a request for action (e.g., a request for a check disbursement), a statement that an analysis has been completed (e.g., a home inspection result is satisfactory), a question to which an answer is required (e.g., a customer asking about his account), or any of a variety of messages. In alternative embodiments, the message 100 could be sent on a variety of media, such as an email, a phone call, a phone recording, a letter, a fax, etc. In alternative embodiments, the storage device 101 could be any of a variety of storage units, such as a home computer, a server, etc. Analyzing logic 201 repeatedly reviews messages 100 in the storage device 101. In alternative embodiments, the message 100 is reviewed to determine if the message 100 has been fully dealt with by agents, if specific message subsets have been dealt with, or if message subsets need to be followed up with automatic or human responses.

According to one embodiment, the analyzing logic 201 subdivides the message into several pieces (in the example, into two pieces), according to the analysis of its content. A message subset 200a is then sent to a separate storage unit 210 that is assigned to store messages relating to a specific issue. Another message subset 200b is sent to another storage unit 210 that is assigned to store messages relating to a different issue. Then additional logic 220 and 221 extract from these now thematically organized message subsets 200a and 200b contained in the storage units 210 and 211 the message subsets that need attention.

These subsets 200a and 200b are then directed to agents, such as an agent 230 for the message subset 200a or another agent 231 or a robotic answering agent 232 for the message subset 200b, based on some predetermined criteria. For example, a message may contain an inquiry from a customer asking for the address of the company, asking for a receipt for a check sent in the past month, and asking that a fax be sent with a new order form for the next month's supply. The three inquiries would then be divided into message subsets and each subset would be directed to a different agent who could deal with the specific request. The request could be responded to in any of a variety of ways, including by phone, email, fax, voice mail, automatic response, etc.

In one embodiment, the message subset 200b may first be answered automatically by the robotic answering agent 232 and then be followed up by a human response from a human agent 231. In some embodiments, the agent response to the message subset may be fully automated, requiring no human response at all. For example, approval of a certain loan may be pending (for a customer service center that processes loans) based on the results of a home inspection. When the storage device 101 receives a message saying that the home inspection results are satisfactory, analyzing logic 201, 220 or 221 may pass the message or message subset 100, 200a or 200b to a robotic agent that updates the loan application, triggering a check disbursement without involving a human agent.

As customers are able to send and receive information in a number of ways, the responses to the action requests do not need to necessarily be in the same medium as the action request. For example, a fax may be answered by an email, or an email may be answered by a phone call, etc., depending on customer preferences or a variety of other factors.

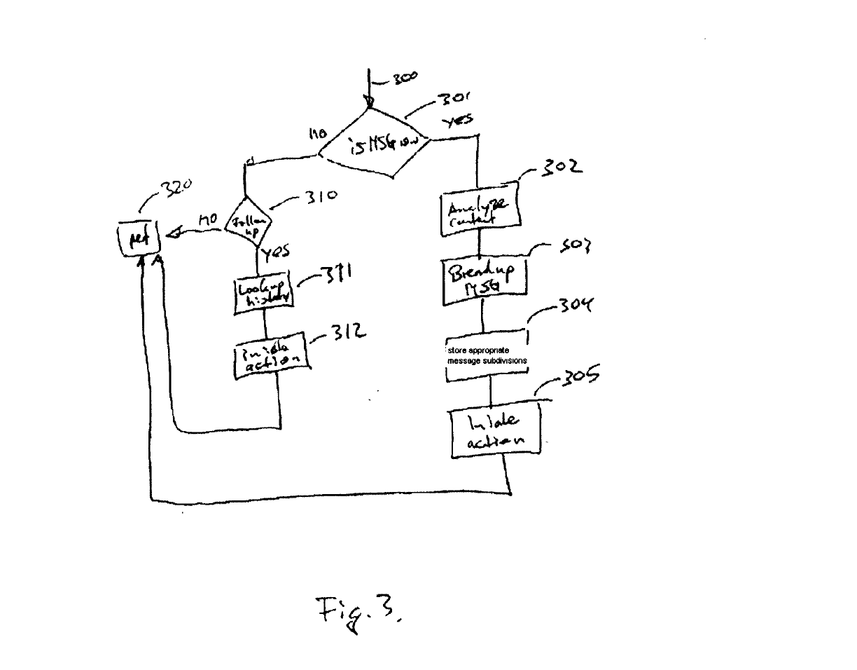

FIG. 3 is a flow diagram, according to one embodiment, describing the analysis process. The program deals with messages on a continuous basis, repeatedly reviewing incoming messages and subsets of messages and also reviewing all unresolved messages remaining in the process.

In one embodiment, a message enters the analyzer routine at step 300, and at step 301, the program checks the message to determine if it is new. If the message is new, the process branches to step 302, where the content is analyzed. Step 303 divides the message into message subsets. In alternative embodiments, the message could be broken into several subsets or it could be maintained as a single message. The process then stores each fragment into a location in step 304 based on predetermined criteria, and finally initiates actions in step 305. The actions may be, in alternative embodiments, alerting agents to deal with the message subsets or queuing pop-up requests for the human or robotic agents to deal with the message subset (as shown in FIG. 2).

If the message is not new, the process branches from step 301 to step 310, where it checks to determine whether a message is flagged for a follow-up. In some cases, a follow-up may be necessary for a message or message subset. For example, if the response is from a robotic CSR, a human follow-up may be required and must be flagged. Step 310 then determines whether the message or message subset has been flagged and either continues the process for a follow-up or terminates the process. If no follow-up is required, the process is terminated at step 320.

If the process determines in step 310 (based on whether the message or message subset has been flagged) that a follow-up is required, then the process moves to step 311 and the history of the message or message subset is looked up. In step 312, the appropriate action is initiated, such as queuing activity requests. In alternative embodiments, the required response may be to print, fax or email a document to a customer, automatically disburse a check, or take some other appropriate action to respond to the customer message or message subset. Following the appropriate response, the process is terminated at step 320.

In one embodiment, the steps of storing, analyzing and finally taking action on messages or message subsets can best be integrated into a workflow system where documents are managed and routed throughout the system. Integration of these steps into a workflow system may result in simpler management of data and may be advantageous in cost and operational view. In one embodiment, messages or message subsets may be automatically augmented by additional information that is either stored in the message processing system itself or in a legacy system. Thus, when a message or message subset is either opened by an agent or processed by an automated subsystem, it contains not only original information, but also supporting information from sources other than the original message or message subset. For example, if a request for bank routing procedures was received, then information containing a bank ABA number and routing procedures could be automatically extracted from a knowledge base and attached to the original message or message subset. For another example, if a request for the amount remaining on a loan balance pursuant to repayment was received, then loan balance information could be automatically extracted from a loan servicing system, repayment procedure information could be automatically extracted from a knowledge base, and both items of information could be attached to the original message or message subset for further processing or transmission to the requester. In alternative embodiments, messages or message subsets may be automatically forwarded to a supervisor for quality assurance purposes. This could be desirable, for example, if a message or message subset involved a customer complaint. In alternative embodiments, escalation procedures may be incorporated into the workflow system. Thus, responses to requests as a whole may be tracked, and if some predetermined time passes, then the whole request may be forwarded to a supervisor or a special queue. Such tracking of a request as a whole will ensure that delay in the handling of a message subset does not result in unacceptable performance.

The processes and embodiments as described above can be stored on a machine-readable medium as instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
receiving a message;
subdividing the message based on an analysis of content in the message; and
sending subdivided sections of the message to an agent based on the analysis of content.

2. The method of claim 1, wherein the agent provides a response to one of the subdivided sections received.

3. The method of claim 2, wherein the subdivided sections of the message are reviewed again to determine if a subsequent response is needed.

4. The method of claim 3, wherein if a subsequent response is needed, the subdivided sections of the message are sent again to an agent to provide the subsequent response.

5. The method of claim 1, wherein the message is analyzed to determine if the subdivided sections of the message have been responded to.

6. The method of claim 5, wherein the subdivided sections of the message not having been responded to by an agent are sent again to an agent to provide a response.

7. A machine-readable storage medium tangibly embodying a sequence of instructions executable by the machine to perform a method, the method comprising:
receiving a message;
subdividing the message based on an analysis of content in the message; and
sending subdivided sections of the message to an agent based on the analysis of content.

8. The machine-readable medium of claim 7, wherein the agent provides a response to one of the subdivided sections received.

9. The machine-readable medium of claim 8, wherein the subdivided sections of the message are reviewed again to determine if a subsequent response is needed.

10. The machine-readable medium of claim 9, wherein if a subsequent response is needed, the subdivided sections of the message are sent again to an agent to provide the subsequent response.

11. The machine-readable medium of claim 7, wherein the message is analyzed to determine if the subdivided sections of the message have been responded to.

12. The machine-readable medium of claim 11, wherein the subdivided sections of the message not having been responded to by an agent are sent again to an agent to provide a response.

13. A system comprising:
a first unit to store a message sent from a message sender;
a parser to subdivide the message based on a message analysis; and
a router to route the subdivided sections of the message to an agent appropriate for the subdivided section.

14. The system of claim 13, wherein the agent provides a response to one of the subdivided sections received.

15. The system of claim 14, wherein the subdivided sections of the message are reviewed again to determine if a subsequent response is needed.

16. The system of claim 15, wherein if a subsequent response is needed, the subdivided sections of the message are sent again to an agent to provide the subsequent response.

17. The system of claim 13, wherein the message is analyzed to determine if the subdivided sections of the message have been responded to.

18. The system of claim 17, wherein the subdivided sections of the message not having been responded to by an agent are sent again to an agent to provide a response.
